(19) United States
(12) Patent Application Publication
(10) Pub. No.: US 2005/0065622 A1
(43) Pub. Date: Mar. 24, 2005

(54) Multiple motor position control

(76) Inventor: Clarence Augustus Lewis, Casco, ME (US)

Correspondence Address: Bourque & Associates P.A., Suite 301, 835 Hanover Street, Manchester, NH, 03104, US

(21) Appl. No.: 10/915,119

(22) Filed: Aug. 10, 2004

Related U.S. Application Data
(60) Provisional application No. 60/494,278, filed on Aug. 11, 2003.

(51) Int. Cl. G05B 19/18

(52) U.S. Cl. 700/56

(57) ABSTRACT

A system and method for storing and controlling the position of an adjustable position motor for later recall and use. The system includes a mechanism for causing an adjustable position motor to be adjusted to least a first preset position. Subsequently, the system electronically determines the first preset position by setting a first counter value while the motor is in the first preset position and subsequently causes the motor to move to a zero or null position wherein a second counter value is established. By subtracting or comparing the first counter value with the second counter value, a positional value for the motor in the first preset position can be established. The positional value is stored, for later recall, and associated with a label such as a job name or number. The system also includes a mechanism by which the motor position information may be recalled, using the associated label. Using the positional value established by comparing the first and second counters, the motor may be brought back to that initial preset position by first starting in the zero or null position and moving the motor as indicated by the positional value.

### FIELD OF THE INVENTION

The general field of the disclosed invention relates to the use of motors for position control of multiple mechanical mechanisms with storage and recall of any number of positions for each mechanism.

### BACKGROUND OF THE INVENTION

There are many production processes where numerous different jobs are run requiring costly lost time and material in changeover from one job to another. One such process is in the printing industry with the printing of newspapers a significant benefactor of this invention. The printing presses used in this industry are highly versatile with the capability of printing a number of rolls of paper simultaneously some in full color and others in black and white newsprint. The printed rolls are brought together into a folder where they are combined and folded into a final product at a high production rate of up to 90,000/newspapers per hour with immediate delivery to the public.

Newspapers printers who have developed the capability of printing high quality four color process printing have pursued the printing of commercial work. As these jobs are run in the idle time normally associated between editions, the commercial work has become a very profitable source of income

For each job change, it is necessary to reposition a number of mechanical devices such as web position compensating rollers, circumferential differential mechanisms and lateral web adjusting mechanisms, so that four process printed colors are in register with each other and to the folder where the final folded product is cut off.

Each time a new job is run a multitude of these mechanisms must be repositioned for the new job and adjusted back again when the regular edition is run.

Currently in most of the installed base of newspaper presses, these adjustments are made manually by the operator by adjusting the mechanical mechanisms directly or through motors that enable the mechanisms to be adjusted remotely.

The present method of manual positioning of the web compensator rollers has a number of disadvantages.

1. Initial pre positioning by the operator is inaccurate requiring that the final position be adjusted from visual inspection of the product while the printing press is running waste material.

2. Manual adjustment is time consuming as the adjustments must be carried out sequentially usually by one individual. The same wasteful procedure in reverse is required when changing back to running the standard edition.

3. Do to the inaccuracy of manual positioning, a great amount of waste time and material is generated in correcting an error in webbing as the error is not easily detected.

Thus there is a real need to automatically store the motor positions for each job and re position these motors whenever the job is rerun.

For many years the registration mechanisms as well as other frequently adjusted mechanisms provided by press manufacturers on their presses have been equipped with motors. The primary purpose of the motors was to allow the operator to make adjustments remotely from his operating console without physically walking to the location of the mechanism to make a manual adjustment.

A variety of different motor types have been used for this purpose with the most common motors of either 2 or 3 phases. Perhaps the most common motor that has been used for this purpose for many years is the 2 phase synchronous motor and specifically the line of synchronous motors manufactured by the Superior Electric Co. under the trade name of SLO SYN. The advantage of the SLO SYN motor over other motor types is its high reliability, and its simplicity of electrical and mechanical interconnections.

The ability of the SLO SYN motor to start and stop within 0.025 seconds eliminates the need for a brake to prevent overrunning or coasting as is required in other 2 and 3 phase motors when accurate positioning using this invention is desired.

Although the SLO SYN motor is ideal and provides the most accurate positioning for many applications using the teachings of this disclosure, it has a number of disadvantages that make it unsuitable for many applications where high inertia and friction loads are encountered.

Thus a major advantage of this invention is the ability to use many different motor types to achieve accurate positioning under all conditions of inertial and friction loads encountered under different applications.

The vast majority of installed printing presses have no provisions for motor position storage and recall with little or no prospects of installing any of the conventional techniques described under prior art all of which would be cost prohibitive and would require significant mechanical modifications of the presses.

This disclosure describes a unique and accurate method of automatic positioning and storage of the positions of multiple motors with recall and pre-positioning of any or all motors from data stored in computer memory.

### DESCRIPTION OF THE PRIOR ART

Prior art motor positioning include stepper motors either in an open or closed loop configuration and the use of an encoder or potentiometer coupled to the output shaft of virtually any type of motor.

Any of these methods of motor position control with a suitable computer interface could be used to provide for motor storage and recall of motor positions in computer memory. Until now there has been no successful method or product that could provide for motor position storage and recall on existing presses.

1. Stepper motor control: Stepper motors are motors that advance a specific amount for each power pulse applied to the windings of the motor. They are highly susceptible to inaccurate counting in applications where high friction and inertial loads are encountered and thus in these applications an encoder is usually employed. Do to the added complexity of power circuitry and its added cost with additional maintenance and cooling requirements stepper motors are rarely used in all but the lowest power applications with little friction and constant low inertia applications.

2. Closed loop potentiometer feedback: This method of position control is the most common method of feedback position control currently in use on existing machines. The output of a potentiometer, (variable resistance ratio device) usually ten turns, is connected through a suitable gear ratio so that the range of the potentiometer covers the entire range of the mechanical mechanism. The position of the potentiometer slider corresponds to the position of the mechanical mechanism with the voltage ratio of the slider voltage to the excitation voltage representing an analogue of the position of the mechanical mechanism.

3. Closed loop encoder feedback. This method substitutes an encoder (usually an optical encoder) for the potentiometer as described above. Digital pulses are generated directly by the optical encoder and when accumulated in a counter represents the position of the mechanical mechanism. While this method can be more accurate than the potentiometer, it requires significant additional complexity and unacceptable costs for most position control applications in view of this disclosure.

In general all of the above methods of position control are limited and suffer from the following disadvantages:

1. For applications requiring power (⅛ HP plus or minus) because of high friction or inertial loading all of the above methods of position control are costs prohibitive in view of this disclosure.

2. All of the above methods of position control require detailed engineering analysis for each application with little leeway in providing stable operation with variations in friction and inertial loading.

3. All of the above methods of position control have limited selection of available gearbox motor combinations and require engineering design for each application to incorporate limit switches which prevent damage to the mechanical mechanisms.

4. All of the above methods of position control require individual selection of all of the parts or assemblies associated with the application from numerous sources. This includes motor, gearbox, limit switches power amplifiers, and computer interface.

5. Because (until this disclosure) there has been no effective single method for position control to satisfy a wide variety of applications, software is not available that provides for storage of multiple motor positions for recall with provisions for auxiliary automatic control applications.

### OBJECTS OF THE INVENTION

Accordingly, the objectives of the present invention are (among others) to circumvent the deficiencies in the prior art and affect the following inspirational goals.

1. To provide a complete single source low cost accurate and reliable positioning system including the use of any type of motor, and including a gearbox, limit switches, computer interface and software to position and control multiple motors and to store multiple positions of any number of motors for later recall.

2. To control any number of existing motors installed on mechanical mechanisms and to provide for the control of the existing installed motors without making any mechanical or electrical changes to the mechanisms to position and control multiple motors and to store multiple positions of any number of motors for later recall

3. Provide performance independent of application friction and inertial loads without special engineering using AC induction motors in place of synchronous motors.

4. Provide a higher dynamic correction range using AC induction motors in place of synchronous motors.

### EXEMPLARY ADVANTAGES

The following list details some of the advantages possible in some of the preferred embodiments of the present invention:

1. To provide for the control of synchronous motors and specifically the line of motors manufactured by Superior Electric Co under the trade name of SLO SYN on either existing or new installations to position and control multiple motors and to store multiple positions of any number of motors for later recall.

2. To position and control 2 or 3 phase AC motors in the same manner as with SLO SYN synchronous motors providing greater power, greater gearbox selection, easily incorporated limit switches, with far greater application versatility and at lower cost than SLO SYN motors.

3. The present invention enables the addition of accurate motor position storage and recall on mechanical mechanisms on printing presses and other like machines using the existing motors with no mechanical or electrical modification of the mechanisms, motors, or the machine upon which the motors are mounted providing significant reductions in time and material waste.

4. The present invention provides the capability of using low cost AC induction motors with far greater tolerance of friction and inertial loads, greater flexibility and selection of motor power and gearbox ratios, and lower cost than any other type of motor suitable for storage of multiple motor positions for later recall.

5. The low pass filter inherent in the AC induction motor due to armature inertia provides automatic gain reduction with time thus providing a much greater dynamic range with increased accuracy and speed of response over synchronous motors.

6. A very simple computer interface provides for remote positioning, automatic positioning, position storage and recall with the interface that enables automatic control of any or all of the motors such as for example to provide for automatic color registration control, tension control, and any other function that can be accommodated by motor position adjustment.

7. Provide the means to introduce discrete manual position changes that are introduced by the operator using a calculator that appears on a touch screen interface.

8. Provide for automatic backlash compensation by always loading out backlash in one direction.

### BRIEF SUMMARY OF THE INVENTION

Synchronous motors and specifically the line of motors manufactured by Superior Electric Co. under the trade name of SLO SYN have been used for remote positioning of mechanical mechanisms for many years. This is especially true on printing presses where these motors have been used to remotely position the many mechanisms that control the registration of multi colors, cut off, and other functions of the printing press which need frequent adjustments that are best accomplished remotely by the operator from his control console.

At present there are hundreds of thousands of SLO SYN motors installed on all kinds of machines and on almost every printing machine. There are equally as many mechanical mechanisms upon which motors superior to the SLY SNO motor such as the AC Induction motor described in this disclosure could be installed.

For existing installations the benefit of position storage and recall as described herein can be provided with no modifications either to the motor and associated mechanical mechanisms or to the existing wiring.

For those installation where motors are required, the AC Induction motor using the teachings of this disclosure can be provided greatly simplifying the application.

However, almost any motor can provide the benefits of position storage and recall using this invention as will be revealed. Thus new applications are possible where inexpensive 3 phase motors equipped with an electromechanical brake could be used to provide significantly higher power.

### BRIEF DESCRIPTION OF THE DRAWINGS

FIG. 1 Mechanical and electrical schematic

FIG. 2 Computer interface to electrical system

FIG. 3 Flow Cart—Clocking Register

FIG. 4 Flow Chart—Store Motor Positions in Job N

FIG. 5 Flow Chart—Recall Stored Motor Positions

FIG. 6 Flow Chart—Manual Corrections

FIG. 7. Flow Chart—Determine Range

### DISCLOSURE OF THE INVENTION

For purposes of simplification a two phase synchronous motor such as those manufactured by Superior Electric and marketed under the trade name of SLO SYN will be used to describe the invention. Additional features that enable the control of 2 phase and 3 phase AC motors to provide nearly the same accuracy as with synchronous motors will then be described.

The SLO SYN motor is ideal as it is synchronous with the power frequency. For 60 CPS AC power the motor will run at 72 RPM independent of load variations that are within its maximum torque capability. These motors, with minimal inertia loads, can achieve full speed or stop in about 0.025 seconds. Thus for example if the mechanical gearing between the motor and mechanical mechanism is such that the mechanism will move for example 24 inches in 4 minutes, than the rate of change of mechanical position is equal to 6 inches per minute. Any desired position can then be achieved by actuating the motor for specific time intervals. To move 12 inches the motor would be actuated for 2 minutes, for 18 inches the motor would be actuated for 3 minutes, and so on.

The motor when used within its design specifications will start and stop in 0.025 seconds. Thus when either starting or stopping the motor in the above example at 6 inches per minute, the position change for either stopping or starting would be (0.025 sec./2)×(6″/minute)=0.001 inch. Thus the accuracy in positioning can be 001″ for virtually any distance or position change at the 6″/minute rate. As long as the torque requirements are not exceeded, the motor will run at a synchronous speed relative to the 60 cycle power frequency. If the 60 cycle power frequency is used as the clock, for determining time intervals, the accuracy will also be unaffected by line frequency variations.

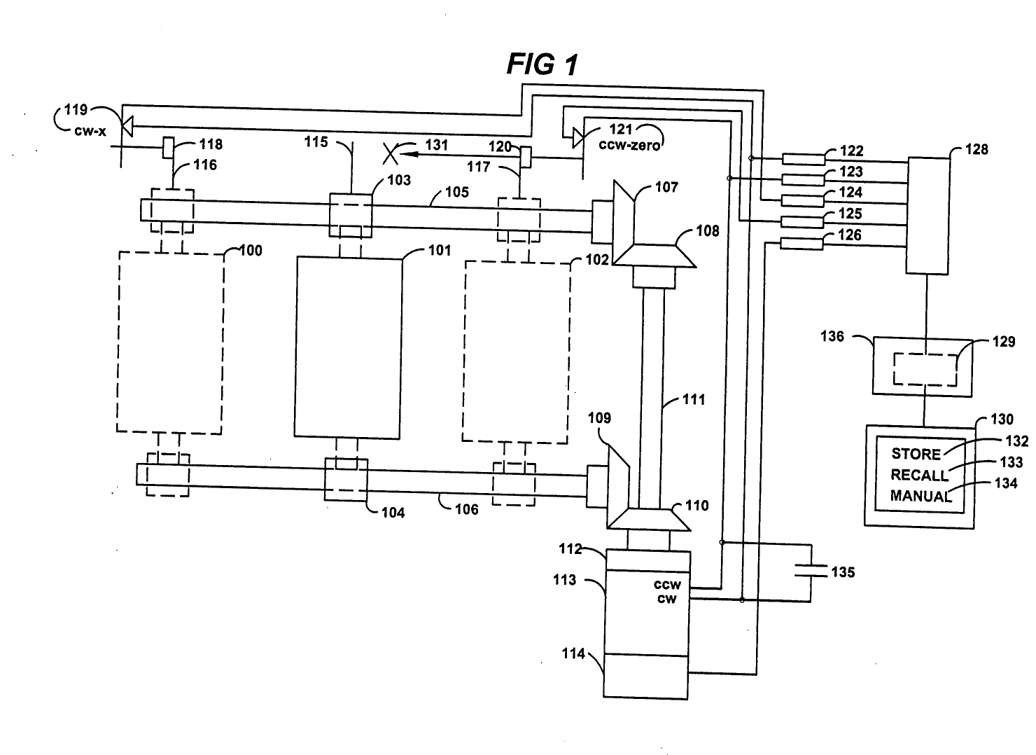

FIG. 1 is an overall schematic drawing of a mechanical and electrical components of this disclosure described in the following:

Roller 101 is attached at each end via threaded nuts 103 and 104 which in turn are attached to threaded lead screws 105 and 106 respectively. Bi-directional motor 113 drives the threaded lead screws 106 and 105 through gear box 112 and bevel gears 110 and 109 and 108 and 107. Thus with the motor running in the clockwise (CW) direction, roller 101 will move to the left as shown dotted at position 100. With the motor running in the counter clock wise (CCW) direction roller 101 will move to the right shown dotted at position 102.

The two extreme positions of roller 101, shown dotted as positions 100 and 102 are determined by the position of limit switches 119 and 121 as arm 115 attached to roller 101 engages each limit switch and changes its mode from normally closed to open stopping motor 113.

136 is a conventional personal computer with a preferred touch screen 130 as the operator interface. Computer 136 can be any personal computer however one that has a PCI bus with PCI board slots is preferred.

129 is a digital I/O circuit board such as manufactured by OPTO 22 their part #PCI-AC5. OPTO 22 is located at 43044 Business Park Drive, Temecula, Calif. 92590. 129 I/O circuit board controls up to 48 I/O control modules that are mounted on rack 128 also manufactured by OPTO-22 (part number G4PB24). A number of different modules are available which can be used to interface various external electrical mechanical components through I/O circuit board 129 and computer 136.

Rack 128 has provisions for up to 24 control modules that can be used as either inputs or outputs for power or to sense voltages as will be explained.

Referring to FIG.1, modules 124 and 125 are AC power output modules, manufactured by OPTO 22 part #G4OAC5.

Module 124 when turned on, applies the AC voltage through limit switch 119 and then to one of the two windings of motor 113 turning the motor in the CW and X direction. Eventually arm 115 attached to one end of roller 101 will come in contact with limit switch 119 opening its contacts stopping the motor. Module 125 applies the voltage through limit switch 121 and then to the other winding of 113. Motor 113 would run in the CCW direction toward zero and eventually arm 115 would open limit switch 121 stopping the motor. The two windings of motor 113 labeled CW and CCW have a capacitor 135 connected between them which provides a phase shift simulating the second phase enabling operation of the motor from a single phase AC power source.

Modules 122 and 123 are AC input sensing modules like those manufactured by OPTO-22 part number G4IAC5. The purpose of these input modules is to sense whenever a voltage is present at either of the two phases indicating that the motor is running or stopped. This information is used in the computer logic to provide the measurement and storage of motor positions as will be explained.

Modules 126 would control an electric brake 114 that would be needed to eliminate overshoot if for example motor 113 were to be a three phase motor.

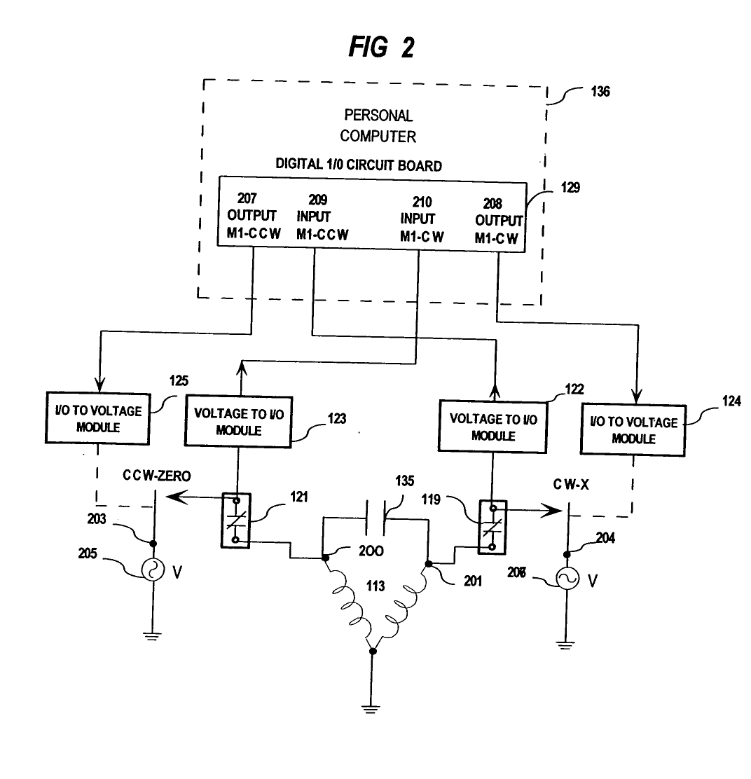

FIG. 2 provides further details and description of the interface of the disclosure between the computer and electromechanical components of FIG. 1

Digital I/O circuit board 129 has two bits configured as outputs with bit 207 activating motor 113 in the CCW direction through relay module 125 and output bit 208 activating motor 113 in the CW direction through relay module 124. Two additional bits are configured as inputs with input bit 209 sensing when the motor stops when running in the CCW direction through input module 122. and input bit 210 sensing when the motor stops when running in the CW direction through input module 123.

In FIG. 2 it motor 113 can be actuated in the CCW direction by writing a logic 1 to bit 207 and actuated in the CW direction by writing a logic 1 to bit 208. Writing a logic 0 to either bit 207 or 208 will stop motor 113 from turning.

Input bit 209 when at logic 1 indicates that motor 113 is running in the CCW direction and when at logic zero indicates that motor 113 is stopped. Input bit 210 when at logic 1 indicates that motor 113 is running in the CW direction and when at logic 0 motor 113 is stopped.

These inputs and outputs under computer program control in combination with an accurate timing counter provide all of the features of storage, control, and recall that are the subject of this disclosure.

It is important to note that one major advantage of this disclosure is to add position control with storage and recall of multiple motor positions for any existing installation using existing motors without making any mechanical or electrical changes.

### MODES OF OPERATION

There are several modes of motor positioning features that can be provided with this invention. The following descriptions describe the invention as positioning a single motor. It is understood that multiple motors can be positioned and controlled simultaneously using this invention.

The number of motors which can be positioned simultaneously is dependent upon the sampling interval of the computer, the number of instructions required for each motor per sampling interval, and the number of instructions that can be performed by the computer per second. If a 0.025 sampling interval is chosen and with 10 instructions per motor/sampling interval, and with a computer capable of one million instructions per second, a total of 250 motors can be positioned simultaneously. With 100 instructions per motor per sampling interval, a total of 250 motors can be positioned simultaneously.

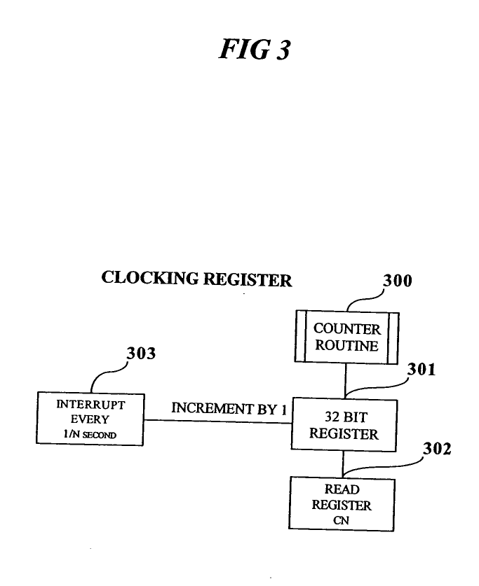

For all modes of operation a counter is used to keep accurate tract of time. Any means of providing accurate timing easily read by the computer is acceptable. FIG. 3 shows an interrupt generated every 1/N seconds that increments a counter directly or indirectly through software The interrupt would be generated from a stable time source such as the crystal oscillator that is part of every computer. Variation in the time between interrupt intervals is not important only that the variation is not greater than the interval which would result in loss time and inaccurate positioning of the motor.

The following flow charts provide a more detailed description of the various software routines of this invention. For simplicity purposes the following nomenclature will be used in the flow charts.

M0 Write 1 (W1) to MO and motor 113 will run in the direction toward zero. Write 0 to MO (W0) and motor 113 will stop.

MX Write 1 to MX and motor 113 will run in the X direction. Write 0 to MX and motor 113 will stop.

RM0 Read RMO and a 1 will indicate that motor 113 is running in the direction toward zero with a 0 indicates that motor 113 is not running in the direction toward zero.

RMX Read RMX and a 1 will indicate that motor 113 is running in the X direction with a 0 indicating that motor 113 is not running in the X direction.

CO This is the first and initial reading of the counter. Each successive reading is noted by C1 C2 and CN as the second and third reading and CN continuous reading until a decision is made.
Store Motor Positions in Job N

This routine provided for measuring an X dimension and storing the value in a job file. The motor is actuated toward zero and the time interval recorded from the time that the motor is first activated and the time when the limit switch opens and a zero motor speed is sensed. This value (X) is stored in a job file for later recall.

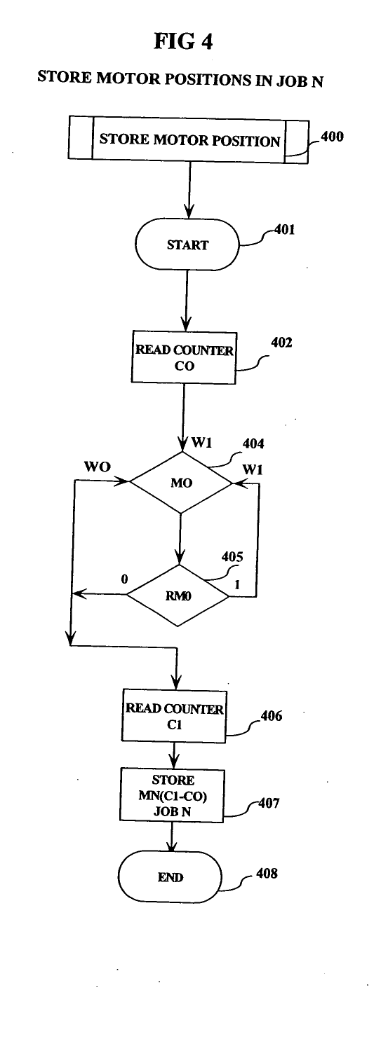

FIG. 4 is a flow chart of the routine for storing a motor position. The operator first adjusts the position of the motor manually to a position labeled as X. After selecting routine 400 on the touch screen 130 of FIG. 1 the operator presses Start 401.

Counter 402 is read with value CO which is stored in computer memory. At the same time a 1 is written to 404 driving motor 113 in the CCW direction toward zero.) Until zero has been reached, a 1 will be read at 405. When the motor stops (limit switch 121 opens), the motor will stop, and 0 will be read at 405. A 0 is written to 404 deenergizing the motor relay. Counter 406 is read at value C1. The difference of C1−CO is the value in time intervals which represents position X. This value is stored in computer memory in a Job file 407 for later recall. This completes the process of converting an unknown position X to time intervals from the zero position.
Recall Stored Motor Positions

This routine provided for recalling a stored motor position X from a job file and positioning the motor to the X position.

The motor is actuated toward zero and when zero is detected the motor is energized in the opposite direction for a time interval represented by X.

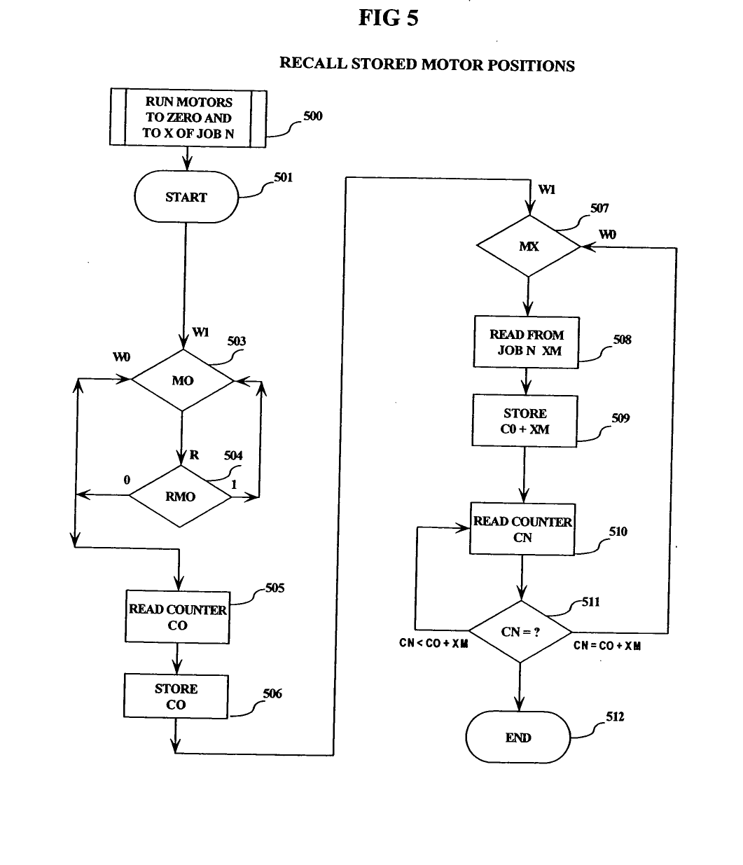

FIG. 5 is a flow chart of the routine for re storing a motor position from job storage. After selecting routine 500 on the touch screen 130 of FIG. 1 the operator presses Start 501.

A 1 is written to 503 to energize motor 113 in the CCW direction toward zero. As long as the motor is running and zero is not reached, a 1 will be read at 504 indicating that the motor is still running. When limit switch 121 opens, the motor will stop, and 0 will be read at 504. 0 is written to 503 deenergizing relay 203. Counter 505 is read at value CO and stored. A 1 is written to 507 which energizes motor 113 CW in the X direction. A motor position is recalled from Job storage 508 as XM. . This value is added to CO from 506 and stored as CO+XM in block 509. For every sampling interval the counter 510 is read and its value compared with the difference of CO+XM.

When CN=CO+XM, a zero is written to MX stopping the motor at position X.
Manual Corrections

After the motor is positioned to X, the operator may introduce small corrections during the run as needed. Using this invention, very accurate and precise positional changes (Delta X) can be accomplished.

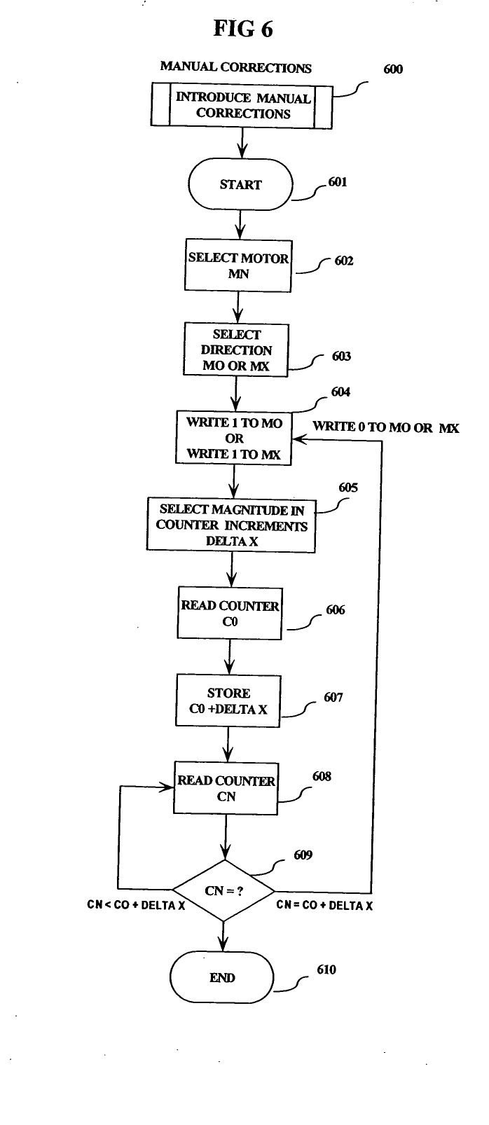

FIG. 6 is a flow chart of the routine that allows the operator to introduce positional changes manually. The positional changes are entered through a touch screen where the operator selects the motors to which the positional changes are to be made and the direction and magnitude of the positional changes.

The routine for introducing manual positional changes 600 is selected and start button 601 is touched on the touch screen. All motors that will be corrected in the same direction and magnitude of Delta X are selected at block 602. At 603 the direction of correction is selected as either MO or MX driving the motor in the zero direction or X direction respectively. At block 604 a 1 is written to either MO or MX energizing the motor in the selected direction. At block 605 the magnitude of the positional changed is introduced preferably through a calculator that appears on the touch screen. At the same time counter 606 is read as CO which is stored. Also stored is CO+Delta X. at 607. Successive comparisons are made 609 until CN=CO+Delta X at which time a 0 is written to 604 stopping the motor.

It should be noted that the same routine can be used when positional changes are made automatically by a computer when using the invention for closed loop control such as in an automatic register control used in the printing industry to maintain accurate color registration. In this instance, the computer will automatically select the motor or motors, and the magnitude and direction that the positional change is to be made.
Positional Range and Absolute Positioning

The total travel or range of the motor can be calculated by running motor 113 from one limit switch 119 to the other limit switch 121 and recording the time interval.

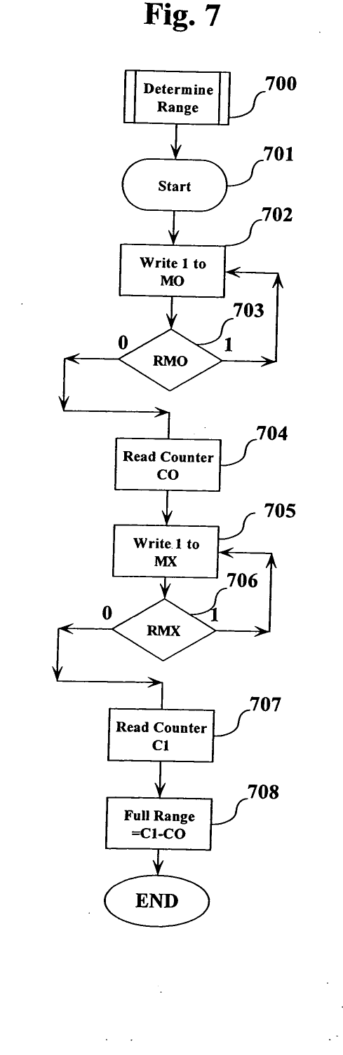

This value can be used to pre-position the motor to any X value within this range. 20 FIG. 7 is a flow chart of the computer program that automatically determines the full scale range. The routine is selected on a touch screen 700 and the process started at 701. A 1 is written to MO at 702 running the motor toward zero. RMO is continuously read at 703 writing a 1 to 702 until a 0 is read at 703. When a zero is read at 703, the counter is read at 704 as CO. A 1 is then written to MX at 705 running the motor in the X direction. RMX at 706 is continuously read writing a 1 to 705 until a 0 is read at 706. When a 0 is read at 706, the counter is read at 708 as C1. The number of sampling intervals (C1-CO) at 708 represents the full range of the motor in sampling intervals.

With an appropriate scale factor the position of the motor can be determined relative to the number of sampling intervals as follows: With a sampling interval of 0.025 seconds, a mechanism such as shown in FIG. 1 would take typically 120 seconds to travel from limit switch 119 to limit switch 121. The distance in inches between limit switches would be typically 24 inches. Thus the conversion factor would be (120 sec./0.025 sec./24″=200 sampling intervals/inch). Thus to position the motor at for example 12 inches, the operator would enter 12 inches into the touch screen and the computer would convert this to 2400 sampling intervals and using the same routine as in FIG. 5 would enter this number into block 508 in place of a number XM read from job storage.

### Motor Types

AC Synchronous Motors

Synchronous motors ideally provide the greatest accuracy with using the teachings of this disclosure, as the synchronous motor runs at a speed that is synchronous with line frequency independent of torque load within the rating of the motor. Thus any torque load variations that occur during the positioning of the synchronous motor do not affect the accuracy of positioning as the motor will run at constant speed irrespective of torque variations within specification during positioning. The disadvantages of synchronous motors are their high price and lack of availability in different sizes and compatible gear boxes.

The high cost is due to the necessity of providing DC excitation which is accomplished with additional electronics and slip rings or by using permanent magnets in the construction of the motor.

The high cost of constructing synchronous motors in comparison with two and three phase induction motors is a major reason for the limited availability of synchronous motors.

There are many applications of positioning mechanical mechanisms that are beyond the capability of synchronous motors as these applications require greater power and speeds and need to drive high friction and inertial loads which are well beyond the capability of synchronous motors. All of these applications can take advantage of this invention using AC induction motors in place of synchronous motors.
AC Two and Three Phase Induction Motors

The converse is true for both two and three phase induction motors. These motors are the simplest in construction and the least costly of all motor types. A wide selection of motors at all power levels with compatible gear boxes is readily available.

A major objective of this invention is to provide positional accuracy and all of the features described herein using two or three phase induction motors in place of synchronous motors.

The basic difference between the synchronous motor and an induction motor is that the induction motor will experience a reduction in speed as the torque load increases. This limitation has until now prevented the use of AC induction motors in position control applications.
Compensation Of Speed Variation of Induction Motors

A family of two and three phase reversible induction motors manufactured by Oriental Motors of Japan and with wide distribution in the US are ideally suited using this invention for replacement of synchronous motors in applications as described herein. These motors come in a wide range of power levels and gear box selections. They incorporate a small friction brake which provides for rapidly stopping the motor when power is removed.

The Oriental reversible induction motors have the following specifications: They are four pole motors which provide a synchronous theoretical speed of 1800 RPM. The torque required for the brake and other friction loads produce a 2% reduction in speed representing a drop of 35 RPM for a base no load speed of 1765 RPM. Applying the full rated torque load will reduce the speed of the motor to 1450 RPM. The torque gradient is (1765−1450)/10=31 RPM drop in speed for each additional 10% of rated torque of the motor. Most applications have fixed or reasonable constant friction loads however they vary greatly in magnitude even for the same application. Usually a motor is selected with a rated torque that is at least four times greater than the actual measured or calculated load. Using this design rule, the speed of the motor would be reduced by 87 RPM to 1688 RPM (1765−2.5×36)=1688. If the load from the mechanism increased by an additional 20%, than there would be an additional drop in speed of 16 RPM representing an error in position of about 1%. For the compensator roller as shown in FIG. 1 whose full range was 40 inches, a 1% position error would result in an actual error of 0.4 inches. This is clearly unacceptable and demonstrates why AC induction motors are not used for position control applications.
Automatic Calibration-Speed Variation AC Induction Motors

This disclosure presents a method of self calibration of the torque required for each application of position control as described herein. It is assumed that the time to travel in each direction from a specific point in the travel to one extreme of the travel called zero and back to the same point again are equal. To record a point or motor position in the travel requires running the motor to zero and recording the time to do so. This time takes into consideration the speed of the motor which varies as a function of the load of the mechanism. When the point is recalled, the motor will first run to zero and then reverse for a time equal to the time interval that was recalled.

This procedure effectively calibrates each mechanism automatically for both major variations in torque requirements from unit to unit and for small variations that occur during positioning.

Another way of looking at the significance of this invention is to first draw a graph of speed vs. time for the synchronous motor and for the AC induction motor.

For the synchronous motor the graph will be a straight line with the position the product of the time to reach a specific point and the velocity of the motor which is constant. It is also represented by the area under the curve which is a rectangle.

For the AC induction motor the line on the graph will not be a straight line but will be irregular as speed variations occur to compensate for torque variations during positioning. However, the area under the curve represents the same position as with the synchronous motor.

### CONCLUSION

This disclosure provides a method for positioning multiple motors using a variety of different motor types that include both Synchronous, and AC Induction Motors.

Advantages include significant cost reduction over prior art, simple retrofit to existing machines with no mechanical or electrical modification necessary, and new application possibilities.

Although a preferred embodiment of the present invention has been illustrated in the accompanying Drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

1. A system for storing and controlling motor position information, comprising:
means for adjusting the position of at least one adjustable position motor to at least a first preset position;
means for electronically determining the at least a first preset position of said at least one adjustable position motor;
means for storing said electronically determined at least a first preset position of said at least one adjustable position motor;
means for associating said electronically determined at least a first preset position of said at least one adjustable position motor with at least one at adjustable position motor position label; and
means, responsive to said at least one adjustable position motor position label, for recalling said stored electronically determined at least a first preset position of said at least one adjustable position motor, and for causing said at least one adjustable position motor to return to said at least a first preset position.

2. The system of claim 1 wherein said means for electronically determining sets a first counter value; causes the at least one adjustable position motor to move to a null or zero position; sets a second counter value; and subtracts the first counter value from the second counter value to determine said at least a first preset position of said at least one adjustable position motor.

3. The system of claim 1 wherein said position label is a job at name or number.

4. The system of claim 1 wherein said means for recalling causes said at least one adjustable position motor to move to a zero or null position and thereafter causes said at least one adjustable position motor to move by an amount indicated by said difference between said first counter value and said second counter value.
